(19) United States
(12) Patent Application Publication
(10) Pub. No.: US 2025/0108640 A1
(43) Pub. Date: Apr. 3, 2025

(54) RECORDING DEVICE

(71) Applicant: SEIKO EPSON CORPORATION, Tokyo (JP)

(72) Inventors: Satoshi NAKATA, MATSUMOTO-SHI (JP); Toru YOSHIZAWA, MATSUMOTO-SHI (JP); Hirokazu ANADA, MATSUMOTO-SHI (JP); Masanari TANAKA, SHIOJIRI-SHI (JP); Katsumi MARUYAMA, AZUMINO-SHI (JP); Soshi AKASAKA, SHIOJIRI-SHI (JP)

(21) Appl. No.: 18/904,991

(22) Filed: Oct. 2, 2024

(30) Foreign Application Priority Data
Oct. 3, 2023 (JP) 2023-171913

(51) Int. Cl. B41J 11/70; B41J 11/00; B41J 11/66

(52) U.S. Cl. CPC B41J 11/706; B41J 11/002; B41J 11/663

(57) ABSTRACT

A recording device includes a recording unit configured to perform recording on a medium; a transport unit configured to transport the medium in a transport direction; a movable blade that cuts the medium on which recording was performed by the recording unit, a carriage that holds the movable blade and is movable along a cutting direction intersecting the transport direction, and a pressing portion that presses a surface of the medium when the cutting unit cuts the medium.

The present application is based on, and claims priority from JP Application Serial Number 2023-171913, filed Oct. 3, 2023, the disclosure of which is hereby incorporated by reference herein in its entirety.

### BACKGROUND

### 1. Technical Field

The present disclosure relates to a recording device.

### 2. Related Art

In the related art, a printing device that is one example of a recording device including a printing unit that is one example of a recording unit, and a cutting unit is disclosed as shown in JP-A-2023-050218. The printing unit prints an image on printing paper, which is an example of a medium, and the cutting unit cuts the printing paper with a cutting blade to divide the printing paper into an upstream portion and a downstream portion in a transport direction.

However, in the printing device described in JP-A-2023-050218, when a printing paper is cut, the printing paper sometimes becomes raised. When the printing paper floats, it becomes difficult to cut the printing paper, and thus there is concern that a cutting failure will occur.

### SUMMARY

A recording device includes a recording unit configured to perform recording on a medium, a transport unit configured to transport the medium in a transport direction, a cutting unit including a cutting blade configured to cut the medium on which recording was performed by the recording unit, and a carriage configured to hold the cutting blade and be movable along a cutting direction intersecting the transport direction, and a pressing portion configured to press a surface of the medium toward a support surface supporting the medium when the cutting unit cuts the medium.

A recording device includes: a recording unit configured to perform recording on a medium, a transport unit configured to transport the medium in a transport direction, a cutting unit including a cutting blade configured to cut the medium on which recording was performed by the recording unit, and a carriage configured to hold the cutting blade and be movable along a cutting direction intersecting the transport direction, and a tension applying unit configured to apply tension to the medium in a direction intersecting with the cutting direction when the cutting unit cuts the medium.

### BRIEF DESCRIPTION OF THE DRAWINGS

FIG. 1 is a perspective view of an appearance of a recording device.

FIG. 2 is a perspective view illustrating main portions of the recording device.

FIG. 3 is a cross-sectional view illustrating the main portions of the recording device.

FIG. 4 is a perspective view of a cutting unit.

FIG. 5 is an enlarged view of a cutting unit and a pressing portion according to Embodiment 1.

FIG. 6 is a side view of the cutting unit and the pressing portion according to Embodiment 1.

FIG. 7 is a side view of the cutting unit and the pressing portion according to Embodiment 1.

FIG. 8 is an enlarged view of a cutting unit and a pressing portion according to Embodiment 2.

FIG. 9 is a bottom view of a cutting unit and a tension applying unit according to Embodiment 3.

FIG. 10 is a bottom view of an angle changing unit according to Embodiment 4.

FIG. 11A is an enlarged view of an angle changing unit according to Embodiment 4.

FIG. 11B is an enlarged view of the angle changing unit according to Embodiment 4.

FIG. 12 is a plan view of a tension applying unit according to Embodiment 5.

### DESCRIPTION OF EMBODIMENTS

### 1. Embodiment 1

A schematic configuration of a recording device 100 according to Embodiment 1 will be described.

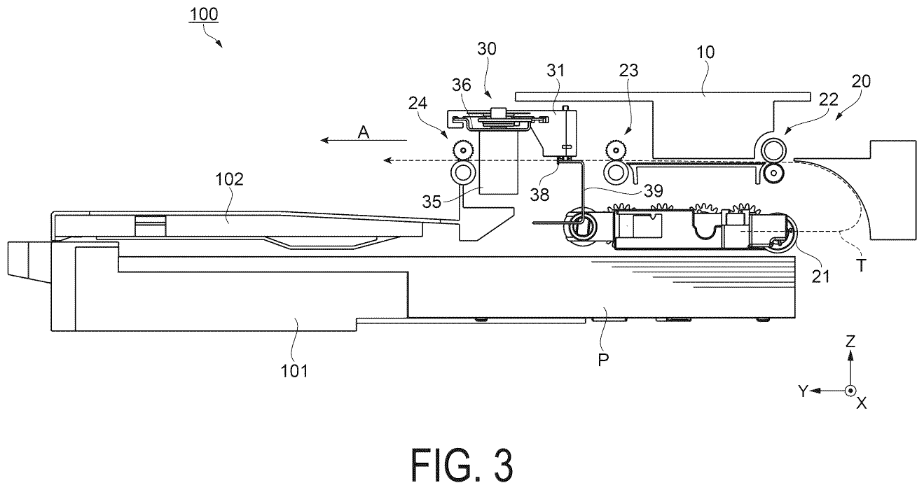

The recording device 100 is, for example, an ink-jet printer capable of recording on a medium P (see FIG. 3). The recording device 100 is not limited to an ink-jet printer and may be a device capable of recording on the medium P.

In the following description, three axes orthogonal to each other are referred to as an X axis, a Y axis, and a Z axis, respectively, as illustrated in each of the drawings. On each axis, a direction indicated by an arrow is a + direction, and an opposite direction thereto is a − direction. A Z-axis direction corresponds to a vertical direction, that is, a direction in which gravity acts, a +Z direction indicates a vertically upward direction, and a −Z direction indicates a vertically downward direction. An X-axis direction and a Y-axis direction correspond to horizontal directions. A +Y direction indicates a forward direction from a device, and a −Y direction indicates a rearward direction of the device. A +X direction indicates a rightward direction from the device viewed toward a front surface of the device, and a −X direction indicates a leftward direction from the device toward the front surface of the device.

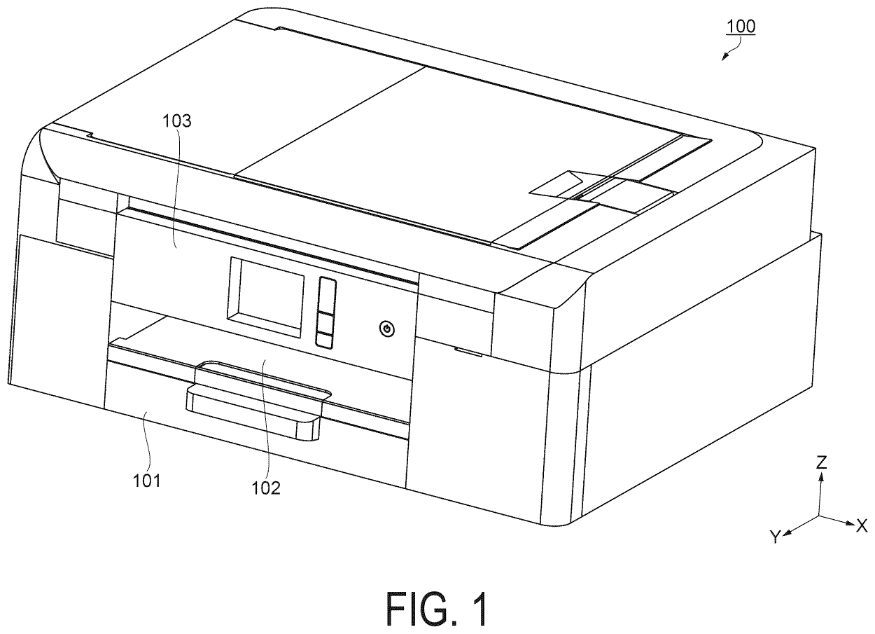

As illustrated in FIGS. 1 to 3, the recording device 100 includes a recording unit 10, a transport unit 20, a cutting unit 30, a medium accommodation portion 101, a paper discharge tray 102, an operation unit 103, and a control unit 104.

The control unit 104 includes a CPU, a flash ROM, and a RAM. The CPU performs various arithmetic processing according to a program stored in the flash ROM, and controls an entire operation of the recording device 100. The flash ROM that is an example of the storage unit is a readable and rewritable nonvolatile memory. The RAM that is an example of the storage unit temporarily stores a variety of information.

As illustrated in FIG. 1, the operation unit 103 is provided on a front surface which is a surface in the +Y direction of the device. Specifically, the operation unit 103 is provided at a center of the front surface of the device in the X-axis direction. The operation unit 103 includes a touch panel display unit, operation buttons, and the like. A user can set or register information related to recording, information related to a size and type of medium P, and the like by operating the operation unit 103.

The medium accommodation portion 101 is provided in the −Z direction of the operation unit 103. The medium accommodation portion 101 is able to accommodate a plurality of media P. The medium accommodation portion 101 is a so-called tray having a bottomed box shape in which a +Z direction side opens so that the medium P can be placed therein. The medium accommodation portion 101 is provided detachably in the device.

The paper discharge tray 102 is provided in the −Z direction of the operation unit 103 and in the +Z direction of the medium accommodation portion 101. The medium P transported by the transport unit 20 is discharged to the paper discharge tray 102.

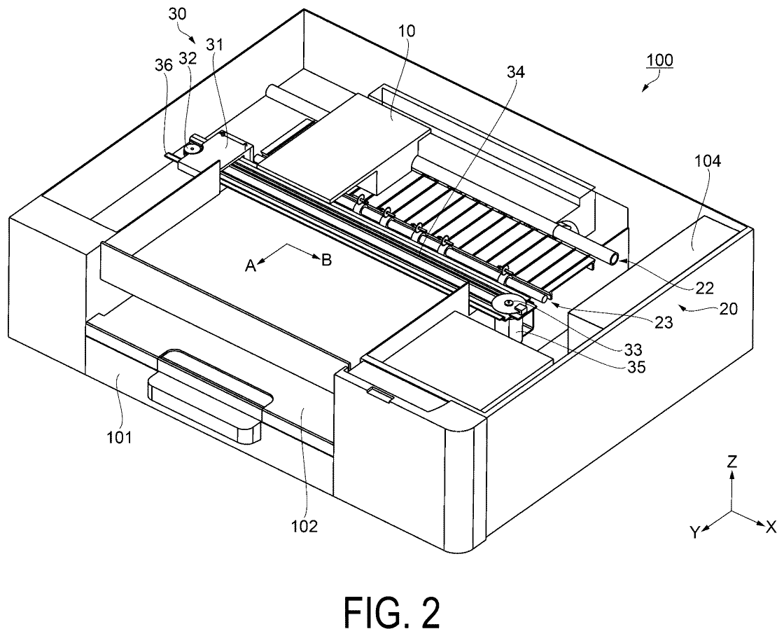

As illustrated in FIGS. 2 and 3, the recording unit 10 includes a liquid ejection head (not shown) that ejects a liquid. The recording unit 10 is movable in the X-axis direction by a moving mechanism (not shown). The recording unit 10 performs recording on the medium P by ejecting liquid while moving in the X-axis direction.

As illustrated in FIG. 3, the transport unit 20 includes a paper feed roller 21, a transport roller pair 22, a first discharge roller pair 23, and a second discharge roller pair 24. The transport unit 20 transports the medium P along a transport path T and discharges the medium P onto the paper discharge tray 102. In the following description, a direction in which the medium P is sent along the transport path T is also referred to as “downstream”, and an opposite direction thereto is also referred to as “upstream”.

The paper feed roller 21 rotates in a state where the paper feed roller 21 comes into contact with the medium P accommodated in the medium accommodation portion 101, thereby sending the medium P located at the uppermost side to the transport path T. The paper feed roller 21 sends the medium P accommodated in the medium accommodation portion 101 to the transport path T one piece at a time.

The transport roller pair 22 is provided downstream of the paper feed roller 21 in the transport path T. The transport roller pair 22 transports the medium P in the +Y direction toward a position facing the recording unit 10. The transported medium P is recorded on by the recording unit 10.

The first discharge roller pair 23 as a first roller pair is provided downstream of the recording unit 10 and upstream of the cutting unit 30 in a transport direction in which the medium P is transported. The first discharge roller pair 23 transports the medium P on which recording is performed by the recording unit 10 in the +Y direction toward the cutting unit 30.

The second discharge roller pair 24 as a second roller pair is provided downstream of the cutting unit 30 in the transport direction in which the medium P is transported. The second discharge roller pair 24 transports the medium P cut by the cutting unit 30 in the +Y direction. The medium P transported by the second discharge roller pair 24 is discharged onto the paper discharge tray 102. The +Y direction that is a direction in which the medium P is transported in the cutting unit 30 is also referred to as a transport direction A. That is, the transport unit 20 transports the medium P in the transport direction A in the cutting unit 30.

As illustrated in FIGS. 2 to 4, the cutting unit 30 includes a carriage 31, pulleys 32 and 33, an endless belt 34, a carriage motor 35, a guide rail 36, a rotary encoder 37, a movable blade 38, and a fixed blade 39. The cutting unit 30 is provided downstream of the recording unit 10 in the transport path T. The cutting unit 30 can cut the medium P on which recording has been performed by the recording unit 10.

The carriage 31 is movable along the guide rail 36 extending in the X-axis direction over a width dimension of the medium P. That is, the carriage 31 is movable in the X-axis direction. The carriage 31 is attached to the endless belt 34 that is stretched over the two pulleys 32 and 33 that are spaced apart in the X-axis direction. One pulley 33 is fixed to a drive shaft of a carriage motor 35. When the carriage motor 35 is driven based on a signal detected by the rotary encoder 37, the carriage 31 moves in the +X direction or −X direction along the X-axis direction.

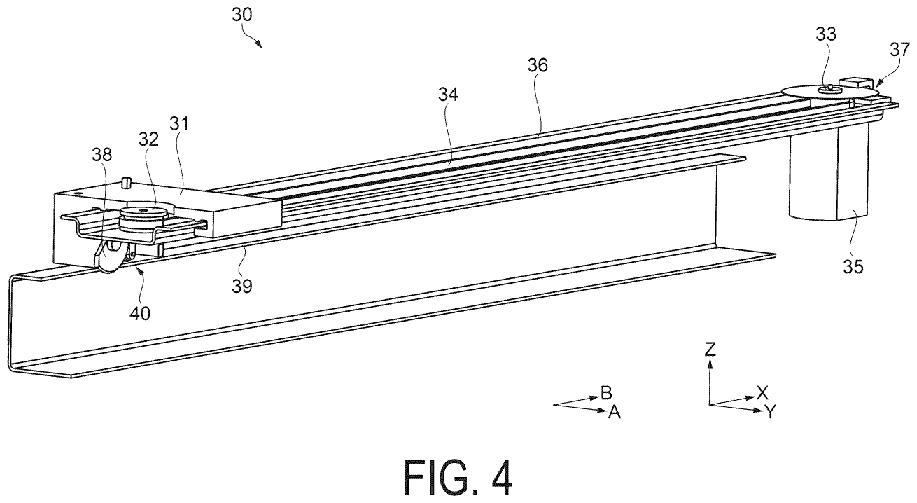

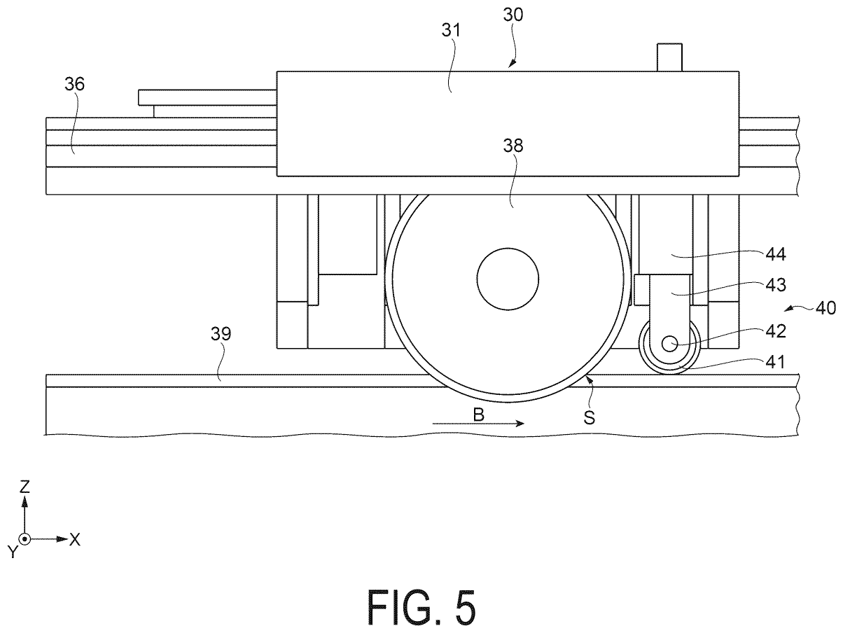

The movable blade 38 serving as a cutting blade is held in the carriage 31. Therefore, the movable blade 38 cuts the medium P on which recording is performed by the recording unit 10, by moving along the X-axis direction together with the carriage 31. As illustrated in FIGS. 2 and 4, the moving direction of the movable blade 38 toward the +X direction is referred to as a cutting direction B. The cutting direction B is a direction intersecting the transport direction A. The movable blade 38 has a contact portion S (see FIG. 5) that comes into contact with the medium P, and cuts the medium P at the contact portion S. In the present embodiment, the movable blade 38 is a so-called circular blade that is a blade having a circular shape.

The fixed blade 39 is provided in the −Z direction of the carriage 31 and upstream of the movable blade 38 in the transport direction A. The fixed blade 39 extends in the X-axis direction to correspond to a movement range of the movable blade 38. The fixed blade 39 has a support surface that supports the medium P. When the movable blade 38 cuts the medium P, the movable blade 38 moves in the cutting direction B to cross the medium P along the fixed blade 39 from a position outside the medium P in the X-axis direction, in a state where the medium P is located on the fixed blade 39. Thus, when the movable blade 38 moves in the cutting direction B in a state where the movable blade 38 is in contact with the fixed blade 39, the medium P is cut. In other words, the medium P is cut by the movable blade 38 and the fixed blade 39.

Further, the medium P is cut by the cutting unit 30 in a state where an upstream in the transport direction A is nipped by the first discharge roller pair 23 and a downstream in the transport direction A is nipped by the second discharge roller pair 24.

As illustrated in FIG. 5, the recording device 100 includes a pressing portion 40 that presses the surface of the medium P in the −Z direction when the cutting unit 30 cuts the medium P. The pressing portion 40 is provided in the carriage 31. Therefore, the pressing portion 40 is provided between the first discharge roller pair 23 and the second discharge roller pair 24 in the transport direction A. Further, the pressing portion 40 also moves in the cutting direction B along with the movement of the movable blade 38 in the cutting direction B.

The pressing portion 40 includes a roller 41, a rotation shaft 42, a roller support portion 43, and a biasing member 44. The roller 41 is able to come into contact with the surface of the medium P and is rotatable around the rotation shaft 42 along the transport direction A. Therefore, when the movable blade 38 and the pressing portion 40 move in the cutting direction B, the roller 41 presses the surface of the medium P while rotating.

The roller support portion 43 holds the rotation shaft 42 and supports the roller 41 via the rotation shaft 42. The biasing member 44 biases the roller 41 in the −Z direction toward the medium P by biasing the roller support portion 43 downward. The biasing member 44 is, for example, an elastic spring.

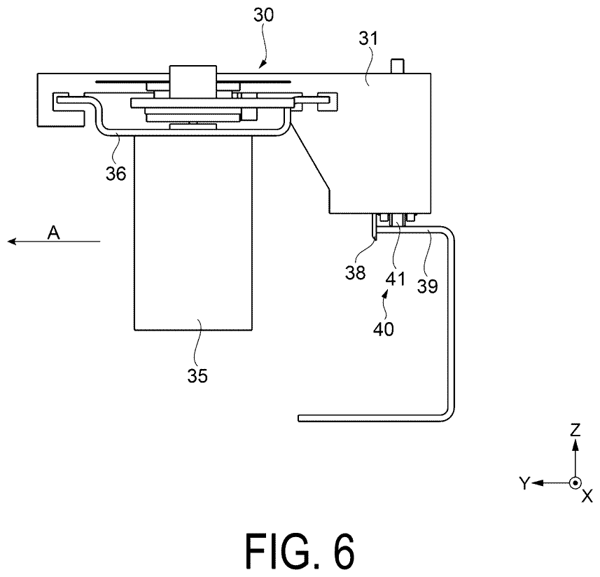

As illustrated in FIG. 6, the roller 41 is provided upstream of the movable blade 38 in the transport direction A. Therefore, when the cutting unit 30 cuts the medium P, the roller 41 presses the surface of the medium P located on the fixed blade 39. The roller 41 presses the surface of the medium P toward a support surface of the fixed blade 39 that supports the medium P. Further, as illustrated in FIG. 5, the roller 41 presses a position downstream of the movable blade 38 in the cutting direction B. However, the roller 41 may be provided to press a range from a position overlapping with the contact portion S when viewed in the transport direction A to a position downstream of the movable blade 38 in the cutting direction B. Further, the roller 41 may be provided to locally press the position overlapping the contact portion S when viewed from the transport direction A.

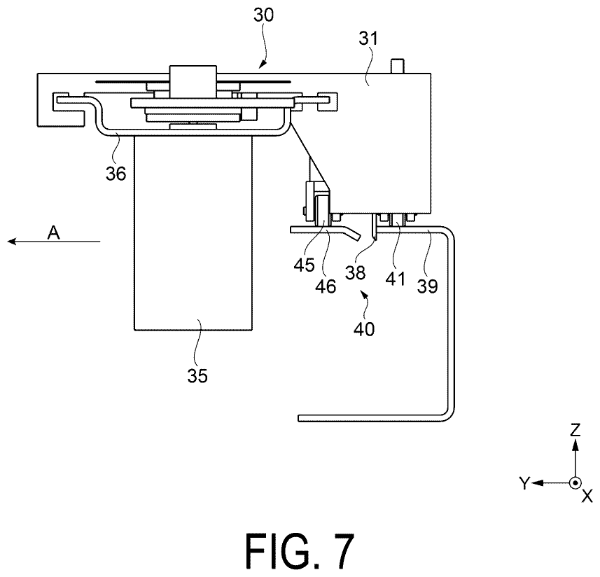

Further, as illustrated in FIG. 7, the pressing portion 40 may include a roller 45 and a sub-frame 46. Since the rotation shaft, the roller support portion, and the biasing member related to the roller 45 are the same as those of the roller 41, description thereof will be omitted. The roller 45 and the sub-frame 46 are provided downstream of the movable blade 38 in the transport direction A. The sub-frame 46 includes a support surface that supports the medium P. When the cutting unit 30 cuts the medium P, the roller 45 presses the surface of the medium P located on the sub-frame 46 in the −Z direction. When the cutting unit 30 cuts the medium P, the roller 45 presses a front surface of the medium P in the −Z direction toward the support surface of the sub-frame 46 that supports the medium P. Further, similarly to the roller 41, the roller 45 may be provided to press the position downstream of the movable blade 38 in the cutting direction B, or may be provided to press the position overlapping the contact portion S when viewed from the transport direction A. Only the roller 41 may be provided, or only the roller 45 may be provided. Further, both the roller 41 and the roller 45 may be provided.

As described above, with the recording device 100 according to Embodiment 1, it is possible to obtain the following effects.

The recording device 100 includes the recording unit 10 that performs recording on the medium P, the transport unit 20 that transports the medium P in the transport direction A, the cutting unit 30 that cuts the medium P, and the pressing portion 40 that presses the surface of the medium P when the cutting unit 30 cuts the medium P. Accordingly, the cutting unit 30 can cut the medium P in a state where the front surface is pressed by the pressing portion 40. Therefore, it is possible to cut the medium P while curbing the floating of the medium P. Therefore, it is possible to prevent the medium P from being cut incorrectly.

The medium P is cut by the cutting unit 30 in a state where the upstream in the transport direction A is nipped by the first discharge roller pair 23 and in a state where the downstream in the transport direction A is nipped by the second discharge roller pair 24, and the pressing portion 40 is provided between the first discharge roller pair 23 and the second discharge roller pair 24 in the transport direction A. Accordingly, since the pressing portion 40 is provided between the first discharge roller pair 23 and the second discharge roller pair 24 in the transport direction A, it is possible to cut the medium P using the cutting unit 30 while effectively curbing the floating of the medium P nipped by the first discharge roller pair 23 and the second discharge roller pair 24. Therefore, it is possible to prevent the medium P from being cut incorrectly.

The pressing portion 40 is provided in the carriage 31. Accordingly, since the pressing portion 40 also moves in the cutting direction B according to the movement of the carriage 31 in the cutting direction B, it is possible to curb floating of the medium P while the cutting unit 30 cuts the medium P. Further, since the movable blade 38 and the pressing portion 40 are provided in the carriage 31, the pressing portion 40 is located in the vicinity of the movable blade 38, and thus it is possible to effectively press the medium P. Therefore, it is possible to prevent the medium P from being cut incorrectly.

The pressing portion 40 includes a roller 41 that rotates around a rotation shaft 42 along the transport direction A. Accordingly, since the roller 41 presses the surface of the medium P while rotating when the pressing portion 40 moves in the cutting direction B, it is possible to reduce friction when the roller 41 presses the medium P. Therefore, it is possible to efficiently curb floating of the medium P while reducing concern that the medium P is damaged by the pressing portion 40.

The pressing portion 40 includes a biasing member 44 that biases the roller 41 toward the surface of the medium P. This makes it possible to effectively press the medium P by biasing the roller 41 using the biasing member 44. In addition, even when the thickness of the medium P varies depending on a type of medium P, it is possible to effectively press the medium P. Thus, floating of the medium P can be curbed.

The roller 41 presses the position downstream of the movable blade 38 in the cutting direction B. Accordingly, since the medium P can be pressed by the pressing portion 40 before the movable blade 38 cuts the medium P, it is possible to effectively curb floating of the medium P when the medium P is cut. Therefore, it is possible to prevent the medium P from being cut incorrectly.

### 2. Embodiment 2

Next, a recording device 100 according to Embodiment 2 will be described. Configurations identical to those in Embodiment 1 will be denoted by the same reference signs and redundant descriptions will be omitted. Embodiment 2 is different in a configuration of a pressing portion 40. The pressing portion 40 includes a sheet member 47 instead of the roller 41.

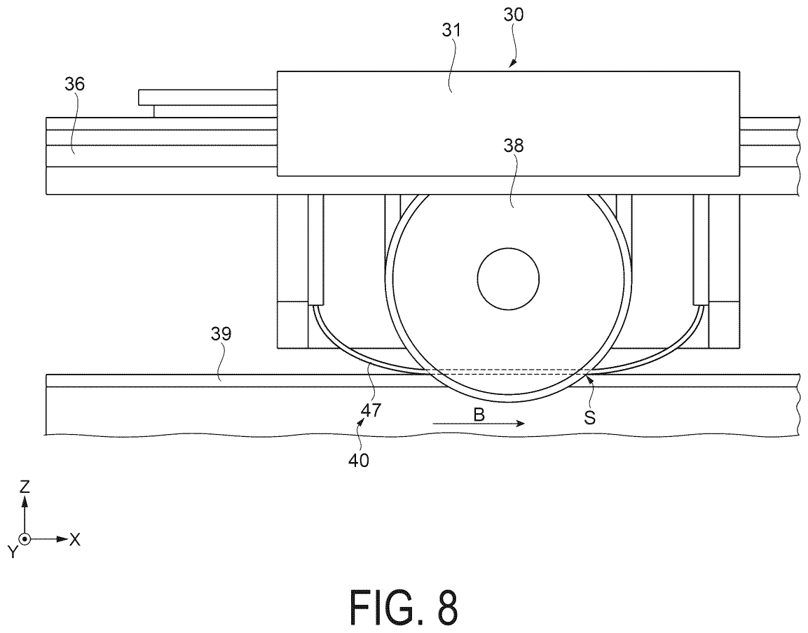

As illustrated in FIG. 8, the sheet member 47 is an elastically deformable member, and extends in a strip shape along the cutting direction B. An upstream end and a downstream end of the sheet member 47 in the cutting direction B are fixed to the carriage 31, and is curved to protrude in the −Z direction. A lower end of the sheet member 47 comes into contact with the surface of the medium P and presses the medium P.

The sheet member 47 is provided to press a position at which at least a part of the sheet member 47 overlaps the contact portion S when viewed in the transport direction A. The sheet member 47 may be provided to press the position downstream of the movable blade 38 in the cutting direction B. Further, the pressing portion 40 may be configured to include the roller 41 of Embodiment 1 together with the sheet member 47.

As described above, with the recording device 100 according to Embodiment 2, it is possible to obtain the following effects.

The pressing portion 40 includes the sheet member 47. This makes it possible to press the medium P with a simple configuration. In addition, concern that the medium P is damaged by the pressing portion 40 can be reduced.

The sheet member 47 is provided to press the position overlapping the contact portion S when viewed from the transport direction A. In other words, the pressing portion 40 can press the position overlapping with the contact portion S when viewed in the transport direction A. This makes it possible to effectively curb floating of the medium P in the vicinity of the contact portion S where the movable blade 38 cuts the medium P. Therefore, it is possible to prevent the medium P from being cut incorrectly.

### 3. Embodiment 3

Next, a schematic configuration of a recording device 100 according to Embodiment 3 will be described. The same configurations as to those in Embodiment 1 will be denoted by the same reference signs and redundant descriptions will be omitted. In Embodiment 3, the recording device 100 may include a tension applying unit 50. When the cutting unit 30 cuts the medium P, the tension applying unit 50 applies tension to the medium P in a direction intersecting the cutting direction B.

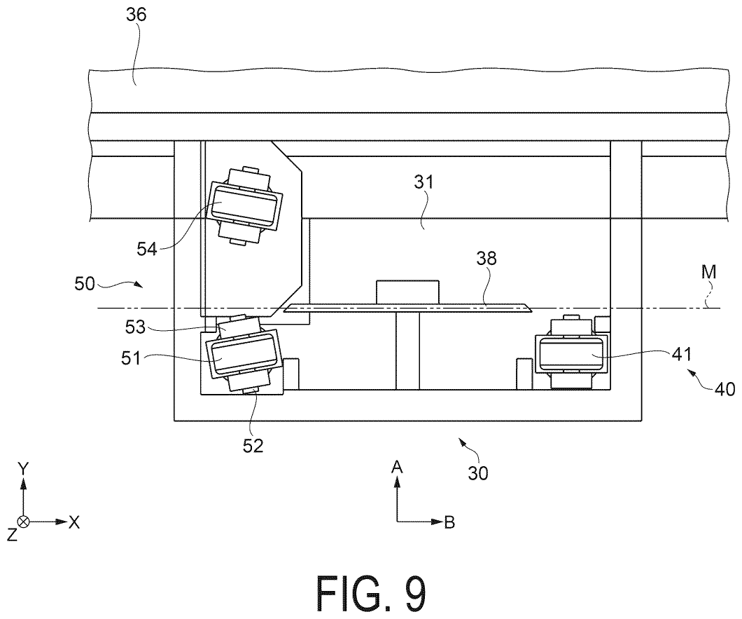

The tension applying unit 50 is provided in the carriage 31 as illustrated in FIG. 9. Therefore, the tension applying unit 50 also moves in the cutting direction B along with the movement of the movable blade 38 in the cutting direction B.

The tension applying unit 50 includes a first tension applying roller 51 as a roller, a rotation shaft 52, a roller support portion 53, and a biasing member (not illustrated). The first tension applying roller 51 can come into contact with the surface of the medium P and can rotate around the rotation shaft 52 along the direction intersecting the cutting direction B. Therefore, when the movable blade 38 and the tension applying unit 50 move in the cutting direction B, the first tension applying roller 51 applies tension to the medium P while rotating. Since the roller support portion 53 and the biasing member are the same as those in Embodiment 1, description thereof will be omitted.

The first tension applying roller 51 is provided upstream of the movable blade 38 in the transport direction A, and is also provided upstream of the movable blade 38 in the cutting direction B. Further, the first tension applying roller 51 has an angle with respect to the cutting direction B such that a downstream end in the cutting direction B is closer to a movement path M of the movable blade 38 than an upstream end in the cutting direction B. Therefore, tension is applied to the medium P cut by the movable blade 38 in the direction intersecting the cutting direction B by the rotation of the first tension applying roller 51. Specifically, the medium P cut by the movable blade 38 opens to move away from the movement path M of the movable blade 38.

The tension applying unit 50 includes a second tension applying roller 54 as a roller. The second tension applying roller 54 is provided downstream of the movable blade 38 in the transport direction A, and is provided upstream of the movable blade 38 in the cutting direction B. Since a peripheral configuration of the second tension applying roller 54 is the same as that of the first tension applying roller 51, description thereof will be omitted. Similarly to the first tension applying roller 51, the second tension applying roller 54 has an angle with respect to the cutting direction B such that a downstream end in the cutting direction B is closer to the movement path M of the movable blade 38 than an upstream end in the cutting direction B. The tension applying unit 50 may include only the first tension applying roller 51 or may include only the second tension applying roller 54. That is, the tension applying unit 50 may include a roller at least one of upstream and downstream of the movable blade 38 in the transport direction A.

Further, in addition to the first tension applying roller 51 and the second tension applying roller 54, the pressing portion 40 may be provided. In the configuration illustrated in FIG. 9, the same pressing portion 40 as that of Embodiment 1, that is, the pressing portion 40 having the roller 41 is disposed upstream of the movable blade 38 in the transport direction A and downstream of the movable blade 38 in the cutting direction B. However, a configuration of the pressing portion 40 is not limited thereto, and for example, the pressing portion 40 may include the sheet member 47 as in Embodiment 2. In the present embodiment, the pressing portion 40 is not an essential configuration.

As described above, with the recording device 100 according to Embodiment 3, it is possible to obtain the following effects.

The recording device 100 includes the recording unit 10 that performs recording on the medium P, the transport unit 20 that transports the medium P in the transport direction A, the cutting unit 30 that cuts the medium P, and the tension applying unit 50 that applies tension to the medium P in a direction intersecting the cutting direction B when the cutting unit 30 cuts the medium P. Accordingly, since the cutting unit 30 can cut the medium P in a state where the tension is applied by the tension applying unit 50, it is possible to cut the medium P while curbing floating of the medium P. Therefore, it is possible to prevent the medium P from being cut incorrectly.

The tension applying unit 50 includes the first tension applying roller 51 provided in the carriage 31. The first tension applying roller 51 is provided upstream of the movable blade 38 in the cutting direction B, and has an angle with respect to the cutting direction B such that a downstream end in the cutting direction B is closer to the movement path M than an upstream end in the cutting direction B. Accordingly, since the tension applying unit 50 moves together with the movement of the carriage 31, it is possible to curb floating of the medium P while the cutting unit 30 cuts the medium P. In addition, since the medium P after being cut opens by the first tension applying roller 51, it is possible to easily cut the medium P.

### 4. Embodiment 4

Next, a schematic configuration of a recording device 100 according to Embodiment 4 will be described. The same configurations as to those in Embodiment 3 will be denoted by the same reference signs and redundant descriptions will be omitted. The Embodiment 4 is different from Embodiment 3 in a configuration of the tension applying unit 50. The tension applying unit 50 of the present embodiment includes an angle changing unit 60 that changes an angle of the first tension applying roller 51 with respect to the cutting direction B according to the movement of the carriage 31 in the cutting direction B.

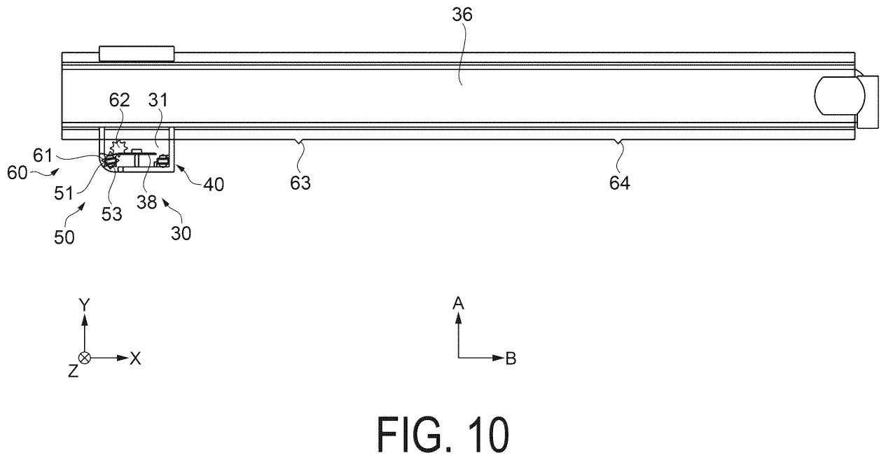

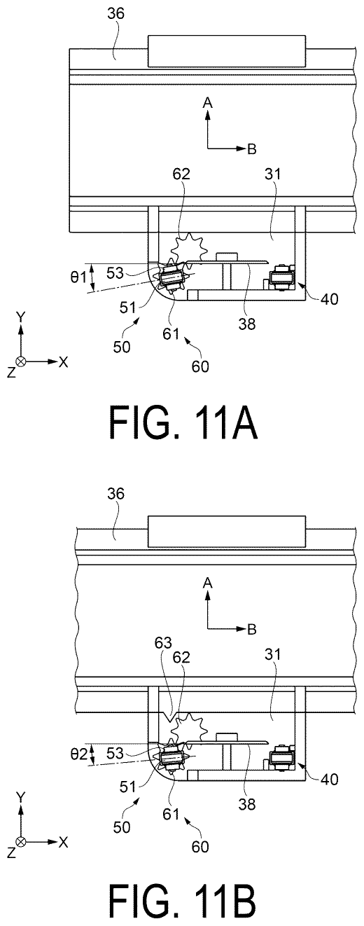

As illustrated in FIGS. 10, 11A and 11B, the angle changing unit 60 includes a first gear 61, a second gear 62, a first angle changing tooth 63, and a second angle changing tooth 64. The first gear 61 is provided in the carriage 31 and is rotatable about a rotation shaft extending in a vertical direction. The roller support portion 53 supporting the first tension applying roller 51 is fixed to the first gear 61. The second gear 62 is provided in the carriage 31 and is rotatable about a rotation shaft extending in a vertical direction. The first gear 61 and the second gear 62 are meshed with each other.

The first angle changing tooth 63 and the second angle changing tooth 64 are provided at an end portion upstream of the guide rail 36 in the transport direction A, and are disposed with a predetermined distance in the cutting direction B. The first angle changing tooth 63 and the second angle changing tooth 64 are protrusions protruding in the −Y direction, and are capable of meshing with the second gear 62.

FIG. 11A shows a case where the carriage 31 is located upstream of the first angle changing tooth 63 in the cutting direction B. The angle of the first tension applying roller 51 with respect to the cutting direction B at this time is θ1. When the carriage 31 further moves in the cutting direction B from the state shown in FIG. 11A, the second gear 62 and the first angle changing tooth 63 mesh with each other. When the carriage 31 further moves in the cutting direction B from this state, the first angle changing tooth 63 rotates the second gear 62 counterclockwise by a predetermined angle. Since the second gear 62 is meshed with the first gear 61, the first gear 61 rotates clockwise with the rotation of the second gear 62. The angle of the first tension applying roller 51 with respect to the cutting direction B is changed by the rotation of the first gear 61. FIG. 11B shows a state where the second gear 62 has passed through the first angle changing tooth 63 and the angle of the first tension applying roller 51 with respect to the cutting direction B has been changed. When the angle of the first tension applying roller 51 with respect to the cutting direction B is θ2, θ2 is smaller than θ1.

When the carriage 31 further moves in the cutting direction B from the state shown in FIG. 11B, the angle of the first tension applying roller 51 with respect to the cutting direction B is further changed from θ2 by the second angle changing tooth 64, as in the case of the first angle changing tooth 63. Although not shown, when the angle of the first tension applying roller 51 with respect to the cutting direction B is θ3, θ3 is smaller than θ2. That is, the angle changing unit 60 decreases the angle of the first tension applying roller 51 with respect to the cutting direction B as the carriage 31 moves in the cutting direction B. In a process in which the carriage 31 returns in the −X direction after the carriage 31 moves in the cutting direction B and the medium P is cut, the angle of the first tension applying roller 51 with respect to the cutting direction B also returns to an original angle. One angle changing tooth may be provided, or three or more angle changing tooth may be provided.

As in Embodiment 3, the pressing portion 40 may be provided in addition to the tension applying unit 50. In the configuration illustrated in FIG. 10, the same pressing portion 40 as that of Embodiment 1 is disposed upstream of the movable blade 38 in the transport direction A and downstream of the movable blade 38 in the cutting direction B. However, the configuration of the pressing portion 40 is not limited thereto, and may be, for example, the same pressing portion 40 as that of Embodiment 2. Also in the present embodiment, the pressing portion 40 is not an essential configuration.

As described above, with the recording device 100 according to Embodiment 4, it is possible to obtain the following effects.

The tension applying unit 50 includes the angle changing unit 60 that changes the angle of the first tension applying roller 51 with respect to the cutting direction B according to the movement of the carriage 31 in the cutting direction B. Accordingly, since the angle of the first tension applying roller 51 with respect to the cutting direction B is changed as the medium P is cut, it is possible to reduce concern that a force is forcibly applied to the medium P and the medium P is damaged.

### 5. Embodiment 5

A schematic configuration of a recording device 100 according to Embodiment 5 will be described. The same configurations as to those in Embodiment 3 will be denoted by the same reference signs and redundant descriptions will be omitted. Embodiment 5 is different Embodiment 3 in a configuration of the tension applying unit 50. The tension applying unit 50 of the present embodiment includes a tension applying roller pair 57 as a third roller pair. The same tension applying unit 50 as that of Embodiment 3 or Embodiment 4 may be further included.

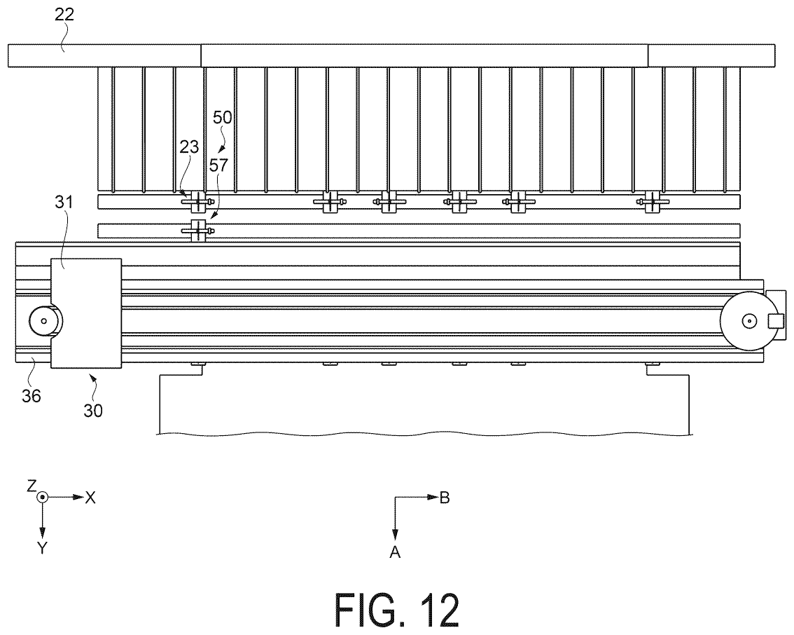

As illustrated in FIG. 12, the tension applying roller pair 57 is provided downstream of the first discharge roller pair 23 and upstream of the cutting unit 30 in the transport direction A. Further, the tension applying roller pair 57 is provided upstream of a center of the movement range of the carriage 31 in the cutting direction B. The tension applying roller pair 57 can nip the medium P using two rollers. Each roller is rotatable about a rotation shaft along the cutting direction B.

When the carriage 31 is located upstream of the tension applying roller pair 57 in the cutting direction B, the control unit 104 does not rotate the tension applying roller pair 57. After the carriage 31 moving in the cutting direction B passes a position of the tension applying roller pair 57, the control unit 104 drives a driving unit (not illustrated) to rotate the tension applying roller pair 57. Specifically, the control unit 104 rotates the tension applying roller pair 57 counterclockwise when viewed along the cutting direction B, that is, in a direction opposite to a direction in which the medium P is discharged. That is, the tension applying roller pair 57 rotates to apply tension to the medium P cut by the movable blade 38, in the direction intersecting the cutting direction B. Specifically, the medium P cut by the movable blade 38 opens to move away from the movement path of the movable blade 38.

The tension applying roller pair 57 may be provided downstream of the cutting unit 30 and upstream of the second discharge roller pair 24 in the transport direction A. In this case, the tension applying roller pair 57 applies tension to the medium P by rotating clockwise when viewed along the cutting direction B. In addition, the tension applying roller pair 57 may be provided both upstream and downstream of the cutting unit 30 in the transport direction A.

As described above, with the recording device 100 according to Embodiment 5, it is possible to obtain the following effects.

The tension applying unit 50 includes the tension applying roller pair 57 that is rotatable around a rotation shaft along the cutting direction B and is able to nip the medium P. The tension applying roller pair 57 is provided upstream of the center of the movement range of the carriage 31 in the cutting direction B, and rotates to apply tension to the medium P when the carriage 31 moving in the cutting direction B passes the position of the tension applying roller pair 57. Accordingly, since the medium P cut by the movable blade 38 opens, it is possible to easily cut the medium P.

### 6. Embodiment 6

A schematic configuration of a recording device 100 according to Embodiment 6 will be described. In the present embodiment, when the medium P is cut by the cutting unit 30, the control unit 104 first moves the carriage 31 in the cutting direction B to cut the medium P. Thereafter, the medium P is further cut by moving the carriage 31 in a direction opposite to the cutting direction B without transporting the medium P. The cutting unit 30 passes through the same position on the medium P in both the case where the cutting unit 30 moves in the cutting direction B and the case where the cutting unit 30 moves in the direction opposite to the cutting direction B.

The control unit 104 may select whether to cut the medium only in the cutting direction B or in both the directions according to the type of medium P. Specifically, when the medium P which is difficult to cut by one cutting operation is cut, the medium P may be cut in both directions.

As described above, with the recording device 100 according to Embodiment 6, the cutting unit 30 cuts the medium P when the carriage 31 moves in the cutting direction B, and then cuts the medium P when the carriage 31 moves in the direction opposite to the cutting direction B. This makes it possible to curb cutting failure and reliably cut the medium P.

### 7. Embodiment 7

Next, a schematic configuration of a recording device 100 according to Embodiment 7 will be described. In the present embodiment, when the medium P is cut by the cutting unit 30, the control unit 104 first executes a first operation of moving the carriage 31 to a predetermined position in the cutting direction B at a first speed. After the carriage 31 has moved to the predetermined position, the control unit 104 executes a second operation of moving the carriage 31 in the cutting direction B at a second speed higher than the first speed.

Here, the predetermined position and a speed difference between the second speed and the first speed may be set in advance to correspond to a type of medium P, or may be appropriately changed and adjusted by a user.

As described above, with the recording device 100 according to Embodiment 7, the control unit 104 executes the first operation of moving the carriage 31 to a predetermined position in the cutting direction B at a first speed, and the second operation of moving the carriage 31 in the cutting direction B at a second speed higher than the first speed after the carriage 31 has moved to the predetermined position. Accordingly, it is possible to curb the cutting failure and reliably cut the medium P by reducing a speed immediately after the start of the cutting operation.

### 8. Embodiment 8

Next, a schematic configuration of a recording device 100 according to Embodiment 8 will be described. In the present embodiment, the control unit 104 executes a drying operation of drying the medium P during a predetermined drying time before the cutting unit 30 cuts the medium P.

The control unit 104 changes the drying time depending on the type of medium P. For example, plain paper is more difficult to cut when a liquid is absorbed than other types of media P. Therefore, before the recorded plain paper is cut, the medium P is dried during a longer drying time than the other types of media P. Further, when an ejection amount of the liquid ejected from the recording unit 10 is larger, it is more difficult to cut the medium. Therefore, the control unit 104 changes the drying time depending on the ejection amount of the liquid ejected from the recording unit 10. Specifically, when the ejection amount of the liquid is larger than a threshold value, the control unit 104 sets the drying time to be longer than that when the ejection amount of the liquid is equal to or smaller than the threshold value. The drying time may be determined depending on both the type of medium P and the ejection amount of the liquid, or may be determined depending on any one of the type of medium P and the ejection amount of the liquid. That is, the control unit 104 may change the drying time depending on at least one of the type of medium P and the ejection amount of the liquid. Further, the user can appropriately change and adjust the drying time instead of determining the drying time depending on the type of medium P or the ejection amount.

As described above, with the recording device 100 according to Embodiment 8, it is possible to obtain the following effects.

The control unit 104 can execute the drying operation of drying the medium P during a predetermined drying time before the cutting unit 30 cuts the medium P. Accordingly, even when the medium P absorbs liquid and is difficult to cut, it is possible to curb cutting failure by cutting the medium P after drying the medium P.

The control unit 104 changes the drying time depending on at least one of the type of medium P and the ejection amount of the liquid ejected from the recording unit 10. Accordingly, even when the medium P absorbs liquid and is difficult to cut, it is possible to efficiently curb the cutting failure by drying the medium P only during a time dependent on the type of medium P or the ejection amount.

The recording device 100 according to the above-described embodiments of the present disclosure is basically assumed to have the configuration as described above, but it goes without saying that change, omission, and the like of part of the configuration can be made without departing from the gist of the present disclosure. Further, the embodiments and other embodiments to be described below can be implemented in combination with one another within a technically consistent range. Hereinafter, the other embodiments will be described.

The pressing portion 40 according to Embodiment 1 and Embodiment 2 is not limited to a configuration in which the roller 41 or the sheet member 47 are included. Further, the pressing portion 40 may not be provided in the carriage 31. For example, when the medium P is being transported, the pressing portion 40 may be located at a retracted position where the pressing portion 40 does not come into contact with the medium P, and when the medium P is cut, the pressing portion 40 may be displaced to be located at an advanced position where the pressing portion 40 comes into contact with the medium P.

The pressing portion 40 according to Embodiment 1 and Embodiment 2 may be provided to be able to press the upstream of the movable blade 38 in the cutting direction B. In addition, at least a portion of the pressing portion 40 may be provided to overlap the movable blade 38 when viewed along the transport direction A.

In Embodiments 1 to 8, a rotation speed of the second discharge roller pair 24 may be higher than a rotation speed of the first discharge roller pair 23. Accordingly, since the cutting unit 30 can cut the medium P in a state where tension is applied, it is possible to cut the medium P while curbing floating of the medium P. Therefore, it is possible to prevent the medium P from being cut incorrectly.

In Embodiments 1 to 8, the rotation speed of the first discharge roller pair 23 and the rotation speed of the second discharge roller pair 24 may be the same, and a diameter of the second discharge roller pair 24 may be larger than a diameter of the first discharge roller pair 23. Accordingly, since the cutting unit 30 can cut the medium P in a state where the tension is applied, it is possible to cut the medium P while curbing floating of the medium P. Therefore, it is possible to prevent the medium P from being cut incorrectly.

What is claimed is:

1. A recording device comprising:
a recording unit configured to perform recording on a medium;
a transport unit configured to transport the medium in a transport direction;
a cutting unit including a cutting blade configured to cut the medium on which recording was performed by the recording unit, and a carriage configured to hold the cutting blade and be movable along a cutting direction intersecting the transport direction; and
a pressing portion configured to press a surface of the medium toward a support surface supporting the medium when the cutting unit cuts the medium.

2. The recording device according to claim 1, wherein
the transport unit includes:
a first roller pair provided downstream of the recording unit and upstream of the cutting unit in the transport direction; and
a second roller pair provided downstream of the cutting unit in the transport direction,
the medium is cut by the cutting unit in a state where the medium is nipped by the first roller pair and the second roller pair, and
the pressing portion is provided between the first roller pair and the second roller pair in the transport direction.

3. The recording device according to claim 1, wherein
the pressing portion presses a position downstream of the cutting blade in the cutting direction.

4. The recording device according to claim 1, wherein
the cutting blade includes a contact portion configured to come into contact with the medium, and
the pressing portion presses a position overlapping the contact portion when viewed from the transport direction.

5. The recording device according to claim 1, wherein
the pressing portion is provided in the carriage.

6. The recording device according to claim 5, wherein
the pressing portion includes a roller rotatable about a rotation shaft along the transport direction.

7. The recording device according to claim 6, wherein
the pressing portion includes a biasing member configured to bias the roller toward the medium.

8. The recording device according to claim 5, wherein
the pressing portion includes an elastically deformable sheet member.

9. A recording device comprising:
a recording unit configured to perform recording on a medium;
a transport unit configured to transport the medium in a transport direction;
a cutting unit including a cutting blade configured to cut the medium on which recording was performed by the recording unit, and a carriage configured to hold the cutting blade and be movable along a cutting direction intersecting the transport direction; and
a tension applying unit configured to apply tension to the medium in a direction intersecting with the cutting direction when the cutting unit cuts the medium.

10. The recording device according to claim 9, wherein
the tension applying unit is provided in the carriage and includes a roller at least one of upstream and downstream of the cutting blade in the transport direction,
the roller is rotatable around a rotation shaft along a direction intersecting with the cutting direction, and is provided upstream of the cutting blade in the cutting direction, and
an angle is formed with respect to the cutting direction such that a downstream end in the cutting direction is closer to a movement path of the cutting blade than an upstream end in the cutting direction.

11. The recording device according to claim 10, wherein
the tension applying unit includes an angle changing unit configured to change the angle according to the movement of the carriage in the cutting direction.

12. The recording device according to claim 9, wherein
the tension applying unit includes a third roller pair rotatable around a rotation shaft along the cutting direction and configured to nip the medium, and
the third roller pair is provided upstream of a center of a movement range of the carriage in the cutting direction, and rotates to apply tension to the medium after the carriage moving in the cutting direction passes a position of the third roller pair.

13. The recording device according to claim 1, wherein
the cutting unit cuts the medium when the carriage moves in the cutting direction, and then cuts the medium when the carriage moves in a direction opposite to the cutting direction.

14. The recording device according to claim 9, wherein
the cutting unit cuts the medium when the carriage moves in the cutting direction, and then cuts the medium when the carriage moves in a direction opposite to the cutting direction.

15. The recording device according to claim 1, comprising:
a control unit, wherein
the control unit executes
a first operation of moving the carriage to a predetermined position in the cutting direction at a first speed; and
a second operation of moving the carriage in the cutting direction at a second speed higher than the first speed after the carriage moved to the predetermined position.

16. The recording device according to claim 9, comprising:
a control unit, wherein
the control unit executes
a first operation of moving the carriage to a predetermined position in the cutting direction at a first speed; and
a second operation of moving the carriage in the cutting direction at a second speed higher than the first speed after the carriage moved to the predetermined position.

17. The recording device according to claim 1, comprising:
a control unit, wherein
the control unit executes a drying operation of drying the medium during a predetermined drying time before the medium is cut by the cutting unit.

18. The recording device according to claim 15, wherein
the recording unit performs recording on the medium by ejecting a liquid, and
the control unit changes the drying time depending on at least one of a type of medium and an ejection amount of the liquid ejected from the recording unit.

19. The recording device according to claim 9, comprising:
a control unit, wherein
the control unit executes a drying operation of drying the medium during a predetermined drying time before the medium is cut by the cutting unit.

20. The recording device according to claim 19, wherein
the recording unit performs recording on the medium by ejecting a liquid, and
the control unit changes the drying time depending on at least one of a type of medium and an ejection amount of the liquid ejected from the recording unit.
